(19) United States
(12) Patent Application Publication
(10) Pub. No.: US 2026/0288936 A1
(43) Pub. Date: Sep. 24, 2026

(54) INFORMATION PROCESSING APPARATUS, INFORMATION PROCESSING METHOD, AND STORAGE MEDIUM

(71) Applicant: NEC Corporation, Tokyo (JP)

(72) Inventor: Daiki TANAKA, Tokyo (JP)

(73) Assignee: NEC Corporation, Tokyo (JP)

(21) Appl. No.: 19/477,541

(22) PCT Filed: May 16, 2023
(86) PCT No.: PCT/JP2023/018341

§ 371 Date: Oct. 22, 2025

(51) Int. Cl. G06F 21/52

(52) U.S. Cl. CPC G06F 21/52; G06F 2221/033

(57) ABSTRACT

An information processing apparatus according to the present disclosure includes: a function extracting unit configured to extract a target function, which is a function set in advance, from a program; a structure extracting unit configured to extract an execution path of the target function extracted from the program, and a condition branch included in the execution path; and an identifying unit configured to identify, from among the extracted condition branches, the condition branch including time as a condition.

### TECHNICAL FIELD

The present disclosure relates to an information processing apparatus, an information processing method, and a storage medium.

### BACKGROUND ART

As one of the countermeasures for supply chain risks, detection of an unauthorized function in software called a backdoor has become more important. Today's computer systems are becoming more complex, making it difficult to configure them using only products from a single company. Therefore, it is common practice to configure a system by procuring products from external sources and combining the procured products. At this point, an inspection for the presence of backdoors in the procured products needs to be conducted by the procuring party.

However, detection of a backdoor in firmware without source code requires considerable time and effort. This is because, in detection of a backdoor in firmware without source code, it is required to perform reverse engineering, conduct detailed analysis of suspicious function groups and execution paths, and manually determine a backdoor. Therefore, as described in Patent Literature 1, an assist by computer technology is required in the work involved in detection of backdoors.

In Patent Literature 1, by analyzing the propagation status of specific data in software and identifying a data flow and code that processes the data, a backdoor that leaks or rewrites confidential information such as passwords are detected, for example.

### CITATION LIST

### Patent Literature

Patent Literature 1: WO2021/028989

### SUMMARY OF INVENTION

### Technical Problem

Here, in the technique described in Patent Literature 1 set forth above, by defining library functions and system calls used by backdoors as policies, functions to be analyzed and execution paths that call them can be identified from within a program.

However, regardless of the presence of a backdoor, the execution path of a program often includes a function that defines a library function and a system call as policies. Ultimately, this requires the manual analysis of candidate execution paths by a human. As a result, there remains a problem that much time and effort are required for detection of a backdoor.

Accordingly, an object of the present disclosure is to provide an information processing apparatus that can solve the abovementioned problem that much time and effort are required for detection of a backdoor.

### Solution to Problem

An information processing apparatus as an aspect of the present disclosure includes: a function extracting unit configured to extract a target function, which is a function set in advance, from a program; a structure extracting unit configured to extract an execution path of the target function extracted from the program, and a condition branch included in the execution path; and an identifying unit configured to identify, from among the extracted condition branches, the condition branch including time as a condition.

An information processing method as an aspect of the present disclosure includes: extracting a target function, which is a function set in advance, from a program; extracting an execution path of the target function extracted from the program, and a condition branch included in the execution path; and identifying, from among the extracted condition branches, the condition branch including time as a condition.

A program as an aspect of the present disclosure includes instructions for causing a computer to execute processes to:
extract a target function, which is a function set in advance, from a program;
extract an execution path of the target function extracted from the program, and a condition branch included in the execution path; and
identify, from among the extracted condition branches, the condition branch including time as a condition.

### Advantageous Effects of Invention

Configured as described above, the present disclosure can achieve reduction of time and effort in detection of a backdoor.

### BRIEF DESCRIPTION OF DRAWINGS

FIG. 1 is a block diagram showing a configuration of a detection apparatus in a first example embodiment of the present disclosure.

FIG. 2 is a diagram showing an example of a program to be processed by the detection apparatus disclosed in FIG. 1.

FIG. 3 is a diagram showing a state of processing by the detection apparatus disclosed in FIG. 1.

FIG. 4 is a diagram showing a state of processing by the detection apparatus disclosed in FIG. 1.

FIG. 5 is a diagram showing a state of processing by the detection apparatus disclosed in FIG. 1.

FIG. 6 is a flowchart showing operation of the detection apparatus disclosed in FIG. 1.

FIG. 7 is a block diagram showing a hardware configuration of an information processing apparatus in a second example embodiment of the present disclosure.

FIG. 8 is a block diagram showing a configuration of the information processing apparatus in the second example embodiment of the present disclosure.

### EXAMPLE EMBODIMENT

### First Example Embodiment

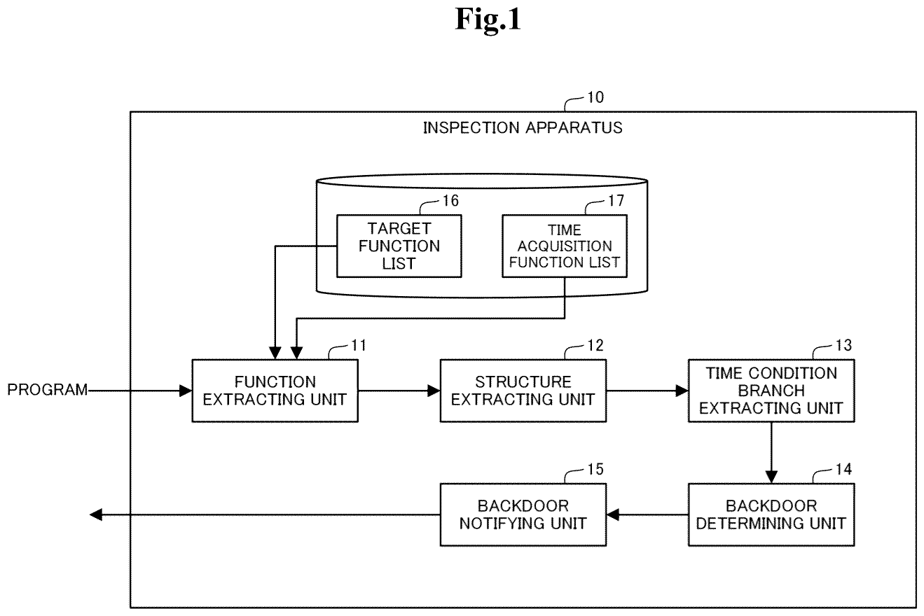

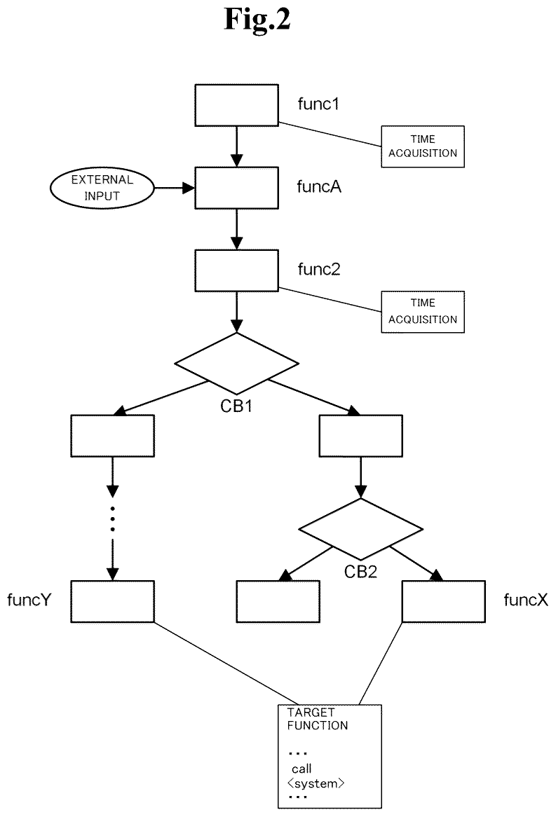

A first example embodiment of the present disclosure will be described with reference to FIGS. 1 to 6. FIG. 1 is a diagram for describing the configuration of an inspection apparatus, and FIGS. 2 to 6 are diagrams for describing the operation of the inspection apparatus.

### [Configuration]

An inspection apparatus 10 in this example embodiment is for performing an inspection to detect code with a specific attribute such as code that may become an unauthorized function called a backdoor, from a program that can be executed by a computer. However, code detected by the inspection apparatus 10 is not necessarily limited to code that may become a backdoor, and code that belongs to a specific attribute with another characteristic set in advance may be detected. A program to be inspected may be of any content.

The inspection apparatus 10 is configured with one or a plurality of information processing apparatuses each including an arithmetic logic unit and a memory unit. As shown in FIG. 1, the inspection apparatus 10 includes a function extracting unit 11, a structure extracting unit 12, a time condition branch extracting unit 13, a backdoor determining unit 14, and a backdoor notifying unit 15. The respective functions of the function extracting unit 11, the structure extracting unit 12, the time condition branch extracting unit 13, the backdoor determining unit 14, and the backdoor notifying unit 15 can be implemented by execution of a program for implementing the respective functions stored in the memory unit by the arithmetic logic unit. Moreover, the inspection apparatus 10 stores a target function list 16 and a time acquisition function list 17 in the memory unit. The respective components will be described in detail below.

The function extracting unit 11 receives input of a program to be inspected, analyzes the input program, and extracts a target function to be analyzed from the program. At this point, the target function is a function set in advance and is stored in the target function list 16. As an example, the target functions stored in the target function list 16 are a call site that calls a function exerting a sensitive effect on a computer system in which the program may be executed, a function recognized as requiring caution based on preliminary analysis inside the function, and so forth. Sensitive functions are, for example, the fwrite function, which can overwrite confidential files, the system function, which can execute commands, and so forth.

Further, the function extracting unit 11 analyzes the input program and extracts a time acquisition function, which is a library function acquiring time, from the program. At this point, the time acquisition function is a function set in advance, and is stored in the time acquisition function list 17. As an example, the time acquisition functions stored in the time acquisition function list 17 are library functions acquiring absolute time, specifically functions such as the time function in the UNIX-based OS. Absolute time refers to time that is not affected by the system's internal environments such as computer startup time and program execution time; for example, the UNIX time, which represents the number of seconds elapsed since 00:00 on Jan. 1, 1970 (UTC), corresponds to it. On the other hand, the difference between times obtained at two time points is expressed as relative time. In this example embodiment, absolute time and relative time are respectively treated as distinct temporal characteristics.

An example of the program to be inspected is illustrated as a tree in FIG. 2. As shown in FIG. 2, the program to be inspected includes target functions funcX and funcY corresponding to the abovementioned sensitive functions, and time acquisition functions func1 and func2 corresponding to the abovementioned library functions acquiring time. Further, the program includes funcA, which is a function that performs external input, and condition branch functions CB1 and CB2. In this case, the function extracting unit 11 extracts the target functions and the time acquisition functions from the program shown in FIG. 2, as follows.

Target function: [funcX, funcY]
Time acquisition function: [func1, func2]

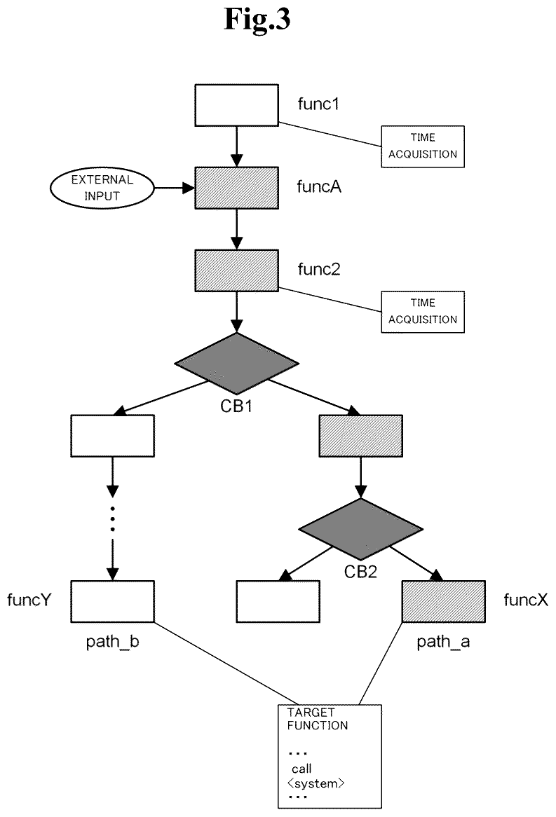

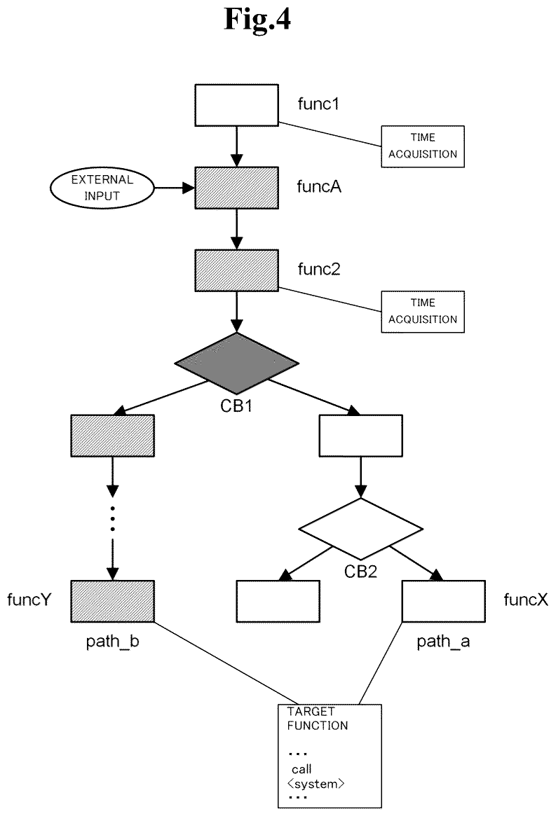

The structure extracting unit 12 analyzes the input program and extracts the execution paths of the target functions extracted by the function extracting unit 11 and the condition branches included in the execution paths. For example, in extracting the execution paths and the condition branches, the structure extracting unit 12 uses the technique described in Patent Literature 1, thereby analyzing the propagation status of data input from outside within software, and identifying and extracting a data flow and a processing flow. For example, in the case of a program tree as shown in FIG. 2, the structure extracting unit 12 extracts an execution path path_a that starts at the external input function funcA and ends at the target function funcX as indicated by diagonal lines and hatching in FIG. 3, and an execution path path_b that starts at the external input function funcA and ends at the target function funcY as indicated by diagonal lines and hatching in FIG. 4. At this point, the structure extracting unit 12 also extracts the condition branches CB1 and CB2 included in the execution paths path_a and path_b. Subsequently, for each of the extracted execution paths path_a and path_b, the structure extracting unit 12 creates a list of function and condition branch included in the execution path as set forth below. In the following, the list for the execution path_a is denoted by EP #1, and the list for the execution path_b is denoted by EP #2. The structure extracting unit 12 is not limited to extracting the execution paths shown in the following lists, but extracts all applicable execution paths.

EP#1: [funcA, func2, [CB1, CB2], ..., funcX]
EP#2: [funcA, func2, [CB1], ..., funcY]
...

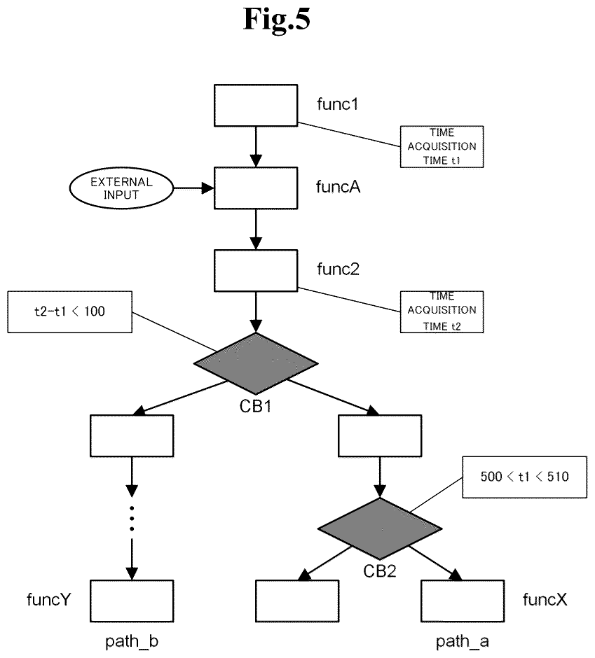

The time condition branch extracting unit 13 (identifying unit) analyzes the input program and extracts a condition branch whose condition is related to time. For example, in branch extraction, the time condition branch extracting unit 13 uses the technique described in Patent Literature 1, thereby analyzing the data flow of temporal data acquired by the time acquisition function, and extracting the condition branch whose condition includes the temporal data from among the condition branches extracted by the structure extracting unit 12. Here, the contents of the condition branches CB1 and CB2 extracted as shown in FIGS. 3 and 4 will be described with reference to FIG. 5. First, the condition branch CB1 is expressed as “t2−t1<100”, where t1 and t2 included in the condition denote times acquired by the time acquisition functions func1 and func2, respectively. Accordingly, the condition branch CB1 includes time as the condition. Further, the condition branch CB2 is expressed as “500<t1<510”, where t1 included in the condition denotes the time acquired by the time acquisition function func1. Accordingly, the condition branch CB2 includes time as the condition.

In this manner, the time condition branch extracting unit 13 extracts the condition branches CB1 and CB2 included in the execution paths path_a and path_b. Consequently, the time condition branch extracting unit 13 identifies the execution path_a and path_b including either of the extracted condition branches CB1 or CB2 as possibly being backdoors. Furthermore, the time condition branch extracting unit 13 creates a list correlating each time acquisition function extracted as described above with a condition branch using time acquired by the time acquisition function as the time of the condition. For example, the condition branch list #1 indicates that the time acquired by the time acquisition function func1 is used by the condition branches CB1 and CB2. Also, the condition branch list #2 indicates that the time acquired by the time acquisition function func2 is used by the condition branch CB1.

#1: [func1, [CB1, CB2]]
#2: [func2, [CB1]]
...

The backdoor determining unit 14 (identifying unit) determines, in the condition branches included in the list and including time as condition, whether the time used as the condition is used by a backdoor. In other words, the backdoor determining unit 14 conducts the backdoor determination of an execution path identified as possibly being a backdoor, by examining the characteristics of the time used as the condition of the condition branch included in the execution path. As for the characteristics of time used as the condition of the branch, there are absolute time, which is time unaffected by internal environments such as computer or software execution timing, and relative time, which is time elapsed from system execution or time that is the difference between times acquired at two time points. As will be described below, the backdoor determining unit 14 determines whether the characteristics of time used as a condition in a condition branch is absolute time or relative time, and determines a condition branch using absolute time as a condition branch with aa high possibility of being a backdoor trigger.

Here, the reason that the backdoor determining unit 14 makes the determination as set forth above will be described. First, as an example, the following is a source code representation that has absolute time in a condition branch.

```
void func() {
  ...
  t = time(NULL); //UNIX time acquisition
  if (1664204400 < t <1664290799) { //2022/9/27 00:00:00~23:59:59
  ...
  }
  ...
}
```

Further, as an example, the following is a source code representation with relative time as the condition. At this point, a function that acquires relative time or a branch that has relative time as a condition are not extracted, as they have a low possibility of being a backdoor trigger.

```
void func() {
  ...
  t = clock(); // acquisition of CPU time elapsed since process initiation
  if (1000 < t < 2000) { // if between 1 and 2 seconds have elapsed since process
initiation,
    ...
  }
  ...
}
```

Then, only functions that acquire absolute time are described in the aforementioned time acquisition function list 17, so that it is unnecessary to consider functions that acquire relative time. On the other hand, it is also possible to represent relative time using absolute time, in which case it is treated as a condition branch using relative time. As one example, the following is a source code representation using an absolute time acquisition function for acquisition of relative time.

```
void func() {
  ...
  start = time(NULL); // UNIX time acquisition
  end = time(NULL); // UNIX time acquisition
  if (end*1000000-start < 2000000) {//If elapsed time between two time points is less
than 2 seconds,
  ...
  }
  ...
}
```

For example, periodic execution such as execution every hour is obtained by calculation with the acquired absolute time and a constant, and does not satisfy the requirement for relative time, which is “the difference in time acquired at two points”. Accordingly, it is determined that the possibility of being a backdoor trigger is high as absolute time. As an example, the following is a source code representation for executing periodically.

```
void func() {
  ...
  t = time(NULL); // UNIX time acquisition
  ...
( if t%3600 == 0) {// 0 minutes 0 seconds every hour
    ...
  }
  ...
}
```

Then, the backdoor determining unit 14 determines, based on the condition branches extracted by the time condition branch extracting unit 13, a condition branch using absolute time as a condition branch with a high possibility of being a backdoor trigger. That is to say, the backdoor determining unit 14 determines an execution path including a condition branch using absolute time, as code having a possibility of being a backdoor (code belonging to a specific attribute). On the other hand, the backdoor determining unit 14 determines a condition branch using relative time, as a condition branch with a low possibility of being a backdoor trigger. This is because a backdoor is triggered by input information known only to the attacker and follows an execution path unique to the backdoor, so that relative time using time unknown to the attacker, such as time of computer startup, is considered to have a low possibility of being used as a backdoor trigger.

In the determination by the backdoor determining unit 14 as to whether time used as a condition in a condition branch is absolute time or relative time, it is determined as relative time when a plurality of absolute times propagate in the condition of the condition branch, and it is determined as absolute time when only one propagates. For example, it is assumed that the time condition branch extracting unit 13 has created a list as follows.

```
  #1: [func1, [CB1, CB2]]
  #2: [func2, [CB1]]
...
```

In the example above, the condition branch CB2 uses only the time acquired by a single time acquisition function func1 without any duplication in the list, and is therefore determined to be a condition branch using absolute time, that is, a condition branch with a high possibility of being a backdoor trigger. On the other hand, values acquired by time acquisition functions at two points propagate in the condition branch CB1, it is determined that a possibility of being a backdoor trigger is low. Subsequently, the backdoor determining unit 14 creates and outputs a list for the condition branch CB2 determined as being a backdoor trigger with a high possibility. At this point, the condition branch CB1 is excluded from the list because of relative time.

The backdoor notifying unit 15 (identifying unit) determines, based on the list of condition branches determined by the backdoor determining unit 14 as highly possible to be backdoors and the list of execution paths extracted by the structure extracting unit 12, an execution path that includes even one condition branch determined as highly possible to be a backdoor trigger as an execution path highly possible to be a backdoor, and notifies the inspector accordingly. The notification destination may be, for example, an operator performing the backdoor detection operation, but it is also possible to output to another device or program. For example, in the above case, the following execution path EP #1 including the condition branch CB2 is determined and notified as an execution path with a high possibility of being a backdoor.
EP #1: [funcA, func2, [CB1, CB2], . . . , funcX]

### [Operation]

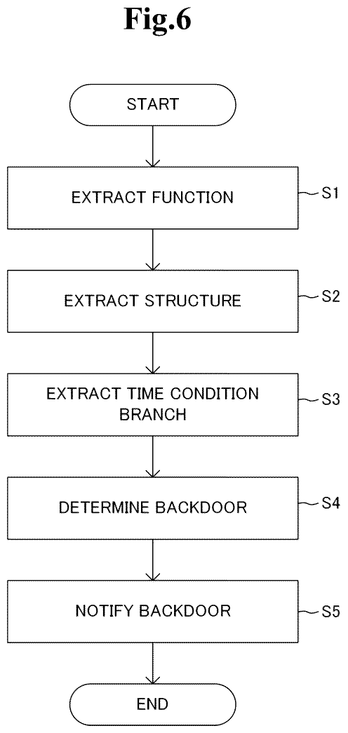

Next, an inspection method (information processing method) enabled by the operation of the inspection apparatus 10 set forth above will be described with reference to a flowchart of FIG. 6.

First, the inspection apparatus 10 analyzes an input program and extracts, from the program, a target function to be analyzed and a time acquisition function acquiring time (step S1). For example, the inspection apparatus 10 acquires, as a target function stored in the target function list 16, a call site that calls a function exerting a sensitive effect on the computer system, a function recognized as requiring caution based on preliminary analysis inside the function, and so forth. Further, for example, the inspection apparatus 10 acquires the time function, which is a library function acquiring absolute time, as a time acquisition function stored in the time acquisition function list 17.

Next, the inspection apparatus 10 analyzes the input program and extracts an execution path of the target function and a condition branch included in the execution path (step S2). For example, in a case where the input program has a tree structure as shown in FIG. 2, the inspection apparatus 10 extracts an execution path path_a that starts at the external input function funcA and ends at the target function funcX as shown in FIG. 3, and an execution path path_b that starts at the external input function funcA and ends at the target function funcY as shown by diagonal lines and hatching in FIG. 4. At this point, the inspection apparatus 10 also extracts the condition branches CB1 and CB2 included in the respective execution paths path_a and path_b. Then, for each of the extracted execution paths path_a and path_b, the inspection apparatus 10 creates a list of functions and condition branches included in the execution path.

Next, the inspection apparatus 10 analyzes the input program and extracts a condition branch in which time is related to condition (step S3). For example, as shown in FIG. 5, the inspection apparatus 10 extracts the condition branches CB1 and CB2 because the condition branches CB1 and CB2 use time as conditions. Then, the inspection apparatus 10 creates a list correlating each of the time acquisition functions with a condition branch using time acquired by the time acquisition function as time of the condition.

Next, the inspection apparatus 10 determines, in condition branches including time as the conditions, whether the time used as the condition has a characteristic used by a backdoor (step S4). Specifically, the inspection apparatus 10 determines whether the time used as the condition is absolute time. At this point, the inspection apparatus 10 examines time used by the time of the condition branch based on the aforementioned list of time acquisition functions and condition branches, and determines the condition branch using only one absolute time as the condition branch using the absolute time and determines it as the condition branch as being highly possible to be a backdoor trigger. Then, the inspection apparatus 10 creates a list of condition branches having absolute time as the conditions.

Next, the inspection apparatus 10 determines an execution path that includes a condition branch using absolute time as a condition, as an execution path with a specific attribute having a high possibility to be a backdoor triggered by time, and outputs a notification to a pre-registered notification destination (step S5).

As described above, the inspection apparatus 10 according to this example embodiment extracts an execution path to a target function from the program, and determines whether there is a possibility that the execution path is a backdoor based on the time of the condition branch. In particular, the inspection apparatus 10 determines, based on the characteristics of the time of the condition branch, that, for example, when the time in the condition branch is absolute time, an execution path including such a condition branch is likely to constitute a backdoor. Accordingly, it becomes easier to detect a backdoor within a program, thereby enabling a reduction in both time and effort.

### Second Example Embodiment

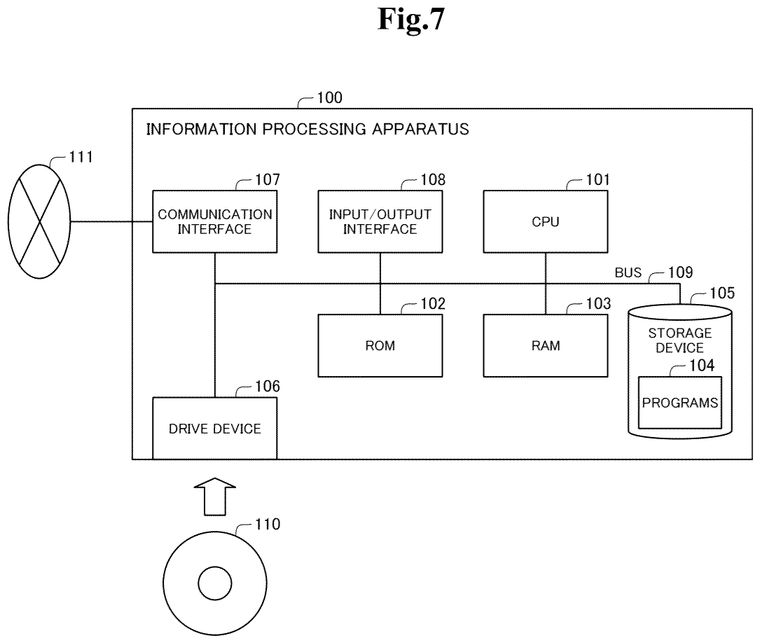

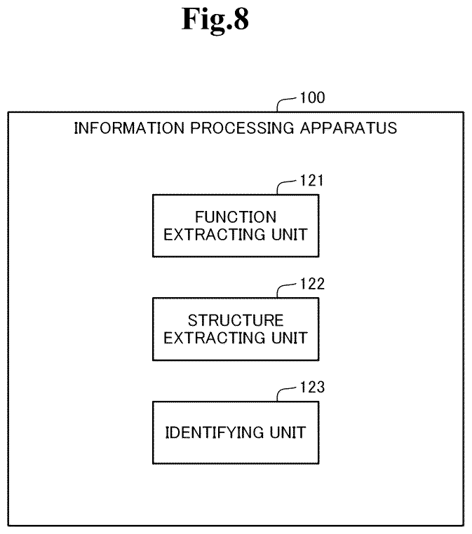

Next, a second example embodiment of the present disclosure will be described with reference to FIGS. 7 to 8. FIGS. 7 to 8 are block diagrams showing a configuration of an information processing apparatus in the second example embodiment. In this example embodiment, the overview of the configuration of the inspection apparatus described in the aforementioned example embodiment is shown.

First, a hardware configuration of an information processing apparatus 100 in this example embodiment will be described with reference to FIG. 7. The information processing apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 7 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

The information processing apparatus 100 can construct and include a function extracting unit 121, a structure extracting unit 122 and an identifying unit 123 shown in FIG. 8, by acquisition and execution of the program 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the aforementioned function extracting unit 121, structure extracting unit 122, and identifying unit 123 may be constructed by dedicated electronic circuits to enable such means.

The function extracting unit 121 extracts a target function, which is a function set in advance, from a program.

The structure extracting unit 122 extracts an execution path of the target function extracted from the program, and a condition branch included in the execution path.

The identifying unit 123 identifies, from among the extracted condition branches, the condition branch in which time is a condition. At this point, the identifying unit 123 determines, based on the time that is the condition in the identified condition branch, whether the execution path including the condition branch has a specific attribute.

According to the above configuration, the present disclosure extracts an execution path to a target function from a program, and identifies a condition branch in which time is a condition from among condition branches included in the execution path. Consequently, based on the time of the identified condition branch, it is possible to determine whether the execution path including the condition branch has a specific attribute, such as a high possibility of being a backdoor. For example, in a case where the time of the condition branch is absolute time, it can be determined that the execution path including the condition branch has a possibility of being a backdoor. As a result, it is facilitated to detect that an execution path within a program has a specific attribute, such as being a backdoor, thereby achieving reduction of time and effort.

The abovementioned program can be stored using various types of non-transitory computer-readable mediums and provided to a computer. The non-transitory computer-readable mediums include various types of tangible storage mediums. Examples of the non-transitory computer-readable mediums include magnetic recording medium (e.g., flexible disk, magnetic tape, hard disk drive), magneto-optical recording medium (e.g., magneto-optical disk), CD-ROM (Read Only Memory), CD-R, CD-R/W, semiconductor memory (e.g., mask ROM, PROM (programmable ROM), EPROM (Erasable PROM), flash ROM, RAM (Random Access Memory)). In addition, a program may be provided to a computer by various types of transitory computer-readable mediums. Examples of the transitory computer-readable mediums include electrical signals, optical signals, and electromagnetic waves. The transitory computer-readable medium may provide a program to a computer via a wired communication channel such as an electric wire and an optical fiber, or via a wireless communication channel.

Although the present disclosure has been described above with reference to the above example embodiments, the present disclosure is not limited to the example embodiments described above. The configuration and details of the present disclosure can be changed in a variety of ways that those skilled in the art can understand within the scope of the present disclosure. Furthermore, at least one of the functions of the aforementioned function extracting unit 121, structure extracting unit 122, and identifying unit 123 may be executed by an information processing apparatus installed and connected at any location on a network; in other words, these functions may be performed on so-called cloud computing.

### Supplementary Notes

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the following configurations.

### (Supplementary Note 1)

An information processing apparatus comprising:
a function extracting unit configured to extract a target function, which is a function set in advance, from a program;
a structure extracting unit configured to extract an execution path of the target function extracted from the program, and a condition branch included in the execution path; and
an identifying unit configured to identify, from among the extracted condition branches, the condition branch including time as a condition.

### (Supplementary Note 2)

The information processing apparatus according to supplementary note 1, wherein
the identifying unit is configured to determine, based on the time included as the condition in the identified condition branch, whether the execution path including the condition branch has a specific attribute.

### (Supplementary Note 3)

The information processing apparatus according to supplementary note 2, wherein
the identifying unit is configured to determine, in a case where an attribute of the time included as the condition in the identified condition branch is an attribute set in advance, that the execution path including the condition branch has a specific attribute.

### (Supplementary Note 4)

The information processing apparatus according to supplementary note 3, wherein
the identifying unit is configured to determine, in a case where the time included as the condition in the identified condition branch is absolute time, that the execution path including the condition branch has a specific attribute.

### (Supplementary Note 5)

The information processing apparatus according to supplementary note 4, wherein:
the function extracting unit is configured to extract a time acquisition function, which is a function acquiring absolute time, from the program; and
the identifying unit is configured to determine, based on time acquired by the extracted time acquisition function and the time included as the condition in the condition branch, whether the time included as the condition in the condition branch is absolute time, and determine, in a case where the time included as the condition in the identified condition branch is absolute time, that the execution path including the condition branch has a specific attribute.

### (Supplementary Note 6)

The information processing apparatus according to supplementary note 5, wherein
the identifying unit is configured to determine, in a case where the time included as the condition in the condition branch is time acquired by the single time acquisition function, that the time included as the condition in the condition branch is absolute time.

### (Supplementary Note 7)

The information processing apparatus according to supplementary note 1, wherein
the structure extracting unit is configured to extract, from the program, the execution path from a function receiving external input to the extracted target function.

### (Supplementary Note 8)

An information processing method comprising:
extracting a target function, which is a function set in advance, from a program;
extracting an execution path of the target function extracted from the program, and a condition branch included in the execution path; and
identifying, from among the extracted condition branches, the condition branch including time as a condition.

### (Supplementary Note 9)

The information processing method according to supplementary note 8, comprising
determining, based on the time included as the condition in the identified condition branch, whether the execution path including the condition branch has a specific attribute.

### (Supplementary Note 10)

The information processing method according to supplementary note 9, comprising
determining, in a case where an attribute of the time included as the condition in the identified condition branch is an attribute set in advance, that the execution path including the condition branch has a specific attribute.

### (Supplementary Note 11)

The information processing method according to supplementary note 10, comprising
determining, in a case where the time included as the condition in the identified condition branch is absolute time, that the execution path including the condition branch has a specific attribute.

### (Supplementary Note 12)

The information processing method according to supplementary note 11, comprising:
extracting a time acquisition function, which is a function acquiring absolute time, from the program; and
determining, based on time acquired by the extracted time acquisition function and the time included as the condition in the condition branch, whether the time included as the condition in the condition branch is absolute time, and determining, in a case where the time included as the condition in the identified condition branch is absolute time, that the execution path including the condition branch has a specific attribute.

### (Supplementary Note 13)

A non-transitory computer-readable storage medium storing a program, the program comprising instructions for causing a computer to execute processes to:
extract a target function, which is a function set in advance, from a program;
extract an execution path of the target function extracted from the program, and a condition branch included in the execution path; and
identify, from among the extracted condition branches, the condition branch including time as a condition.

### REFERENCE SIGNS LIST

10 inspection apparatus
11 function extracting unit
12 structure extracting unit
13 time condition branch extracting unit
14 backdoor determining unit
15 backdoor notifying unit
16 target function list
17 time acquisition function list
100 information processing apparatus
101 CPU
102 ROM
103 RAM
104 programs
105 storage device
106 drive device
107 communication interface
108 input/output interface
109 bus
110 storage medium
111 communication network
121 function extracting unit
122 structure extracting unit
123 identifying unit

What is claimed is:

1. An information processing apparatus comprising:
at least one memory storing processing instructions; and
at least one processor configured to execute the processing instructions to:
extract a target function, which is a function set in advance, from a program;
extract an execution path of the target function extracted from the program, and a condition branch included in the execution path; and
identify, from among the extracted condition branches, the condition branch including time as a condition.

2. The information processing apparatus according to claim 1, wherein at least one processor is configured to execute the processing instructions to
determine, based on the time included as the condition in the identified condition branch, whether the execution path including the condition branch has a specific attribute.

3. The information processing apparatus according to claim 2, wherein at least one processor is configured to execute the processing instructions to
determine, in a case where an attribute of the time included as the condition in the identified condition branch is an attribute set in advance, that the execution path including the condition branch has a specific attribute.

4. The information processing apparatus according to claim 3, wherein at least one processor is configured to execute the processing instructions to
determine, in a case where the time included as the condition in the identified condition branch is absolute time, that the execution path including the condition branch has a specific attribute.

5. The information processing apparatus according to claim 4, wherein at least one processor is configured to execute the processing instructions to:
extract a time acquisition function, which is a function acquiring absolute time, from the program; and
determine, based on time acquired by the extracted time acquisition function and the time included as the condition in the condition branch, whether the time included as the condition in the condition branch is absolute time, and determine, in a case where the time included as the condition in the identified condition branch is absolute time, that the execution path including the condition branch has a specific attribute.

6. The information processing apparatus according to claim 5, wherein at least one processor is configured to execute the processing instructions to
determine, in a case where the time included as the condition in the condition branch is time acquired by the single time acquisition function, that the time included as the condition in the condition branch is absolute time.

7. The information processing apparatus according to claim 1, wherein at least one processor is configured to execute the processing instructions to
extract, from the program, the execution path from a function receiving external input to the extracted target function.

8. An information processing method comprising:
extracting a target function, which is a function set in advance, from a program;
extracting an execution path of the target function extracted from the program, and a condition branch included in the execution path; and
identifying, from among the extracted condition branches, the condition branch including time as a condition.

9. The information processing method according to claim 8, comprising
determining, based on the time included as the condition in the identified condition branch, whether the execution path including the condition branch has a specific attribute.

10. The information processing method according to claim 9, comprising
determining, in a case where an attribute of the time included as the condition in the identified condition branch is an attribute set in advance, that the execution path including the condition branch has a specific attribute.

11. The information processing method according to claim 10, comprising
determining, in a case where the time included as the condition in the identified condition branch is absolute time, that the execution path including the condition branch has a specific attribute.

12. The information processing method according to claim 11, comprising:
extracting a time acquisition function, which is a function acquiring absolute time, from the program; and
determining, based on time acquired by the extracted time acquisition function and the time included as the condition in the condition branch, whether the time included as the condition in the condition branch is absolute time, and determining, in a case where the time included as the condition in the identified condition branch is absolute time, that the execution path including the condition branch has a specific attribute.

13. A non-transitory computer-readable storage medium storing a program, the program comprising instructions for causing a computer to execute processes to:
extract a target function, which is a function set in advance, from a program;
extract an execution path of the target function extracted from the program, and a condition branch included in the execution path; and
identify, from among the extracted condition branches, the condition branch including time as a condition.

14. The information processing method according to claim 12, comprising
determining, in a case where the time included as the condition in the condition branch is time acquired by the single time acquisition function, that the time included as the condition in the condition branch is absolute time.

15. The information processing method according to claim 8, comprising
extracting, from the program, the execution path from a function receiving external input to the extracted target function.
